(19) United States
(12) Patent Application Publication
(10) Pub. No.: US 2012/0145308 A1
(43) Pub. Date: Jun. 14, 2012

(54) METHODS FOR ANODIC BONDING MATERIAL LAYERS TO ONE ANOTHER AND RESULTANT APPARATUS

(76) Inventors: Jiangwei Feng, Painted Post, NY (US); Mike Xu Ouyang, Painted Post, NY (US); Lynn Bernard Simpson, Painted Post, NY (US); Yawei Sun, Horseheads, NY (US); Lili Tian, Corning, NY (US)

(21) Appl. No.: 13/309,844

(22) Filed: Dec. 2, 2011

Related U.S. Application Data
(60) Provisional application No. 61/421,013, filed on Dec. 8, 2010.

(51) Int. Cl. B32B 37/02; B32B 38/10

(52) U.S. Cl. 156/151; 156/273.1; 156/379.7; 156/250

(57) ABSTRACT

Methods and apparatus provide for: disposing an intermediate layer formed from at least one of: a metal, a conductive oxide, and combined layers of the metal and the conductive oxide, on one of a first material layer and a second material layer; and coupling the first and second material layers together via an anodic bond between the intermediate layer and the other of the first and second material layers.

### CROSS REFERENCE TO RELATED APPLICATIONS

This application claims the benefit of priority under 35 U.S.C. §119 of U.S. Provisional Application Ser. No. 61/421,013 filed on Dec. 8, 2010 the content of which is relied upon and incorporated herein by reference in its entirety.

### BACKGROUND

The features, aspects and embodiments disclosed herein relate to the manufacture of devices in which one material layer is to be coupled to another layer, such as in device packaging applications, yielding improved methods and apparatus.

Wafer bonding techniques have been employed to create seals for semiconductor packaging systems for decades. The known wafer bonding techniques may be grouped into two general categories: 1) bonding techniques without an intermediate layer, for instance, direct bonding; and 2) bonding techniques with an intermediate layer. The bonding techniques that employ an intermediate layer include metal bonding, solder bonding, glass frit bonding, organic adhesive bonding, and others. While these techniques may be characterized as providing hermetic seals, in practice the degree of hermeticity varies among the techniques and as a function of the environment to which the seal is exposed. The results are unsatisfactory for certain applications.

Anodic bonding is also widely used in fabrication and packaging of devices, such as pressure sensors, accelerometers and solar cells. The characteristics of an anodic bond include high dimensional precision, and bonding reliability. In the process of forming an anodic bond, for example, between glass and semiconductor, both substrates are heated to an elevated temperature at which the glass substrate becomes slightly conductive, and an electrical potential is applied. The electrical potential is usually applied across the glass and semiconductor with the anode applied to semiconductor and the cathode applied to the glass. When the voltage is applied, the mobile ions, such as alkali Na⁺, in the glass migrate toward the cathode, leaving negatively charged oxygen ions behind or even toward to anode. This leads to metal oxide formation at the interface between the semiconductor and glass and results in a very strong bond.

It has been found that the known parameters of the above techniques are unsatisfactory for some applications, such as in glass-to-glass bonding, and/or insulator-to-oxide insulator. Indeed, direct application of the above techniques to these scenarios result in either poor hermeticity, poor bonding, or both.

### SUMMARY

By way of example, there is a need for improvement in the bonding characteristics and hermeticity achieved during the formation of light processing devices.

One such light processing device is a digital light processor (DLP™), which is a micro-display projection element capable of producing light in accordance with control signaling. A plurality of the DLPs may be packaged in, for example, a digital projector in order to provide image projecting capability to a user. A DLP element includes a glass element (cover glass) to protect delicate micro-electromechanical system (MEMS) structures located behind the glass. In particular, the DLP element employs an array of small mirrors on a semiconductor chip (usually silicon) to reflect light from a projection lamp to form an image. The cover glass protects these structures. The cover glass includes two pieces of layered glass: a layer of front glass (which may be on the order of about 0.3-1.1 mm thick), and an interposer layer of glass. A patterned black matrix coating (e.g., a Cr stack) is deposited on one side of the front glass to define a window aperture for the DLP projector element. A uniform anti-reflection (AR) coating film stack is located on both sides of the front glass. The interposer layer is typically bare glass.

In existing processes, a relatively large sheet of front glass (much larger than an individual DLP element) is bonded to a relatively large, patterned sheet of interposer layer glass. The patterned interposer sheet includes a plurality of apertures therethrough, each aperture for eventual registration with the MEMS structure of an individual DLP element. The sheet of front glass is bonded to the sheet of interposer layer glass by way of ultra-violet (UV) cured organic epoxy. This intermediate structure is bonded to a plurality of MEMS structures at the wafer level, such that each MEMS structure is in registration with a respective one of the apertures through the sheet of interposer layer glass. After bonding to the MEMS structures, the entire stack is diced in order to obtain a plurality of individual DLP elements for packaging into the final DLP projector chip.

It has been discovered that the UV-curable epoxy bonding technique used to bond the sheet of front glass to the sheet of interposer glass does not reliably provide a hermetic seal, especially as to moisture, which may lead to DLP device failure. Indeed, it has been found that an adhesive polymer bonding permeation rate is about 10⁻⁶ cc/sec. Theoretically, other bonding approaches may achieve a hermetic bond, such as fusion, adhesive, eutectic, soldering and glass frit bonding. Fusion bonding, however, normally requires a temperature above 500° C., which is not desirable in many applications, as is the case in forming DLP elements, as such temperatures may adversely affect the optical transmission properties of the front and/or interposer glass. In practice, adhesive bonding does not produce a reliable hermetic seal. A low melting point frit technique (although avoiding undesirably high temperatures) nevertheless requires special composition. For example, such special compositions include soldering materials, which are eutectic, e.g., Au/Sn and In/Sn materials. Such materials, however, are potentially not-compatible with organic acid lubricants and/or other materials used in down-stream processes for fabricating DLP elements.

In accordance with one or more embodiments disclosed and/or described herein, anodic bonding techniques are employed to bond the front glass to the interposer layer glass. Although the anodic bonding technique has been used to bond the semiconductor layers (e.g., silicon wafers) to glass, the technique has been considered by artisans as one of the general bonding techniques categorized as not using an intermediate layer. This is so because one of the materials being bonded is semiconductor and the other glass, with no intermediate layer present. It has been discovered, however, that the anodic bonding technique may be employed in the glass-to-glass context (as well as others as will be discussed later herein).

In accordance with one or more aspects, a metal film, a transparent conductive oxide (TCO) film, and/or combined metal and TCO film are employed as an intermediate layer between two layers of glass. This anodic bonding technique produces a hermetic seal between the two glass layers, thereby making the technique viable for numerous applications, including the aforementioned formation of DLP projectors.

Other aspects, features, advantages, etc. will become apparent to one skilled in the art when the description of the embodiments herein is taken in conjunction with the accompanying drawings.

### BRIEF DESCRIPTION OF THE DRAWINGS

For the purposes of illustrating the various aspects and features disclosed herein, there are shown in the drawings forms that are presently preferred, it being understood, however, that the covered embodiments are not limited to the precise arrangements and instrumentalities shown.

FIG. 1 is a block diagram illustrating the structure of a device in accordance with one or more embodiments disclosed herein;

FIG. 2 is a schematic diagram illustrating methods and intermediate structures formed during the manufacture of the device of FIG. 1;

FIG. 3 is a graph illustrating some optical properties of a sheet of coated glass before and after elevated heating;

FIGS. 4A-4B illustrate alternative methods and structures that may be employed in manufacturing the device of FIG. 1;

FIG. 5 is a schematic diagram illustrating methods and intermediate structures formed during the manufacture of an alternative device;

FIG. 6 is a schematic diagram illustrating methods and intermediate structures formed during the manufacture of a further alternative device;

FIG. 7 is a schematic diagram illustrating methods and intermediate structures formed during the manufacture of a still further alternative device;

FIG. 8 is a schematic diagram illustrating methods and intermediate structures formed during the manufacture of a still further alternative device; and

FIG. 9 is a schematic diagram illustrating methods and intermediate structures formed during the manufacture of a still further alternative device

FIG. 10 illustrates the results of an experiment where two glass material layers were anodically bonded through an intermediate metal layer under differing conditions;

FIG. 11 is a table showing relationships among the bonding temperature, metal film thickness, and transparency during the experiment referenced in FIG. 10;

FIG. 12 illustrates the conditions under which an experiment was conducted where two glass material layers were anodically bonded through an intermediate metal layer under further differing conditions; and

FIG. 13 is a table showing relationships among the bonding temperature, metal film thickness, and modified layer thickness during the experiment referenced in FIG. 12.

### DETAILED DESCRIPTION

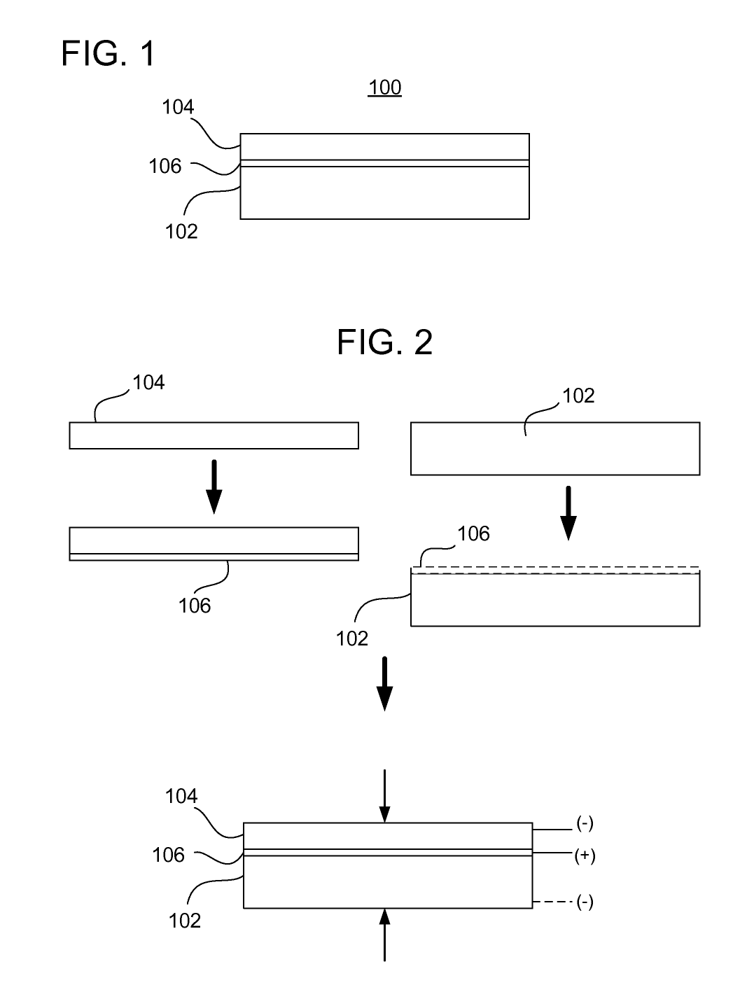

With reference to the drawings, wherein like numerals indicate like elements, there is shown in FIG. 1 a bonded structure 100 in accordance with one or more embodiments disclosed herein. The structure 100 may include a first material layer 102, a second material layer 104, and an intermediate layer 106 formed from a material having characteristics that promote an anodic bond with one or the other of the first and second material layers 102, 104. For example, when the first and second material layers 102, 104 are formed from an insulator, such as glass, the intermediate layer 106 may be formed, for example, from at least one of: a metal, a conductive oxide, and combined layers of the metal and the conductive oxide. As will be developed further below, the first and second material layers 102, 104 of the structure 100 are coupled together via an anodic bond between the intermediate layer 106 and one of the first and second material layers 102, 104.

With reference to FIG. 2, a process for manufacturing the structure 100 is shown. As an initial matter, a determination is made as to which of the first and second material layers 102, 104 is going to receive the anodic bond and which is not. The intermediate layer 106 is disposed on one of first and second material layers 102, 104, namely, whichever layer is not to receive the anodic bond. As shown, a deposition surface of either the first or second material layer 102, 104 is prepared, such as by polishing, cleaning, etc. to produce a relatively flat and uniform surface suitable for receiving the intermediate layer 106. The intermediate layer 106 is disposed on such surface. By way of example, the intermediate layer 106 may be deposited onto the surface of the first or second material layer 102, 104 by way of sputtering, evaporation, frictional adhesion, plating, or other known techniques—so long as a good bond is attained.

For purposes of this example, it is assumed that the first and second layers 102, 104 are formed from glass (such as oxide glass and/or oxide glass-ceramic) and the intermediate layer is formed from a metal (such as Titanium (Ti), Aluminum (Al), Chromium (Cr), and/or a TiAl alloy), which materials are not required, but are believed to be particularly suitable because of their conductivity and good adhesion with glass. It is also assumed that the intermediate layer 106 is deposited onto a surface of the first material layer 102 by some appropriate technique, such as evaporation, sputtering, or other suitable technique.

Next, the first and second material layers 102, 104 are brought into contact to form a stack, including: the first material layer 102, the intermediate layer 106, and the second material layer 104. As the intermediate layer 106 is already bonded (via the chosen deposition technique) to the first material layer 102, the initial contact of the intermediate layer 106 and the second material layer 104 is achieved via a mechanical process.

The intermediate layer 106 may be bonded to the second material layer 104 using an anodic bonding process (which is also referred to as an electrolysis process). A basis for a suitable anodic bonding process may be found in U.S. Pat. No. 7,176,528, the entire disclosure of which is hereby incorporated by reference. Portions of this process are discussed below. In the bonding process, appropriate surface cleaning of the bonding surface of the second material layer 104 and the exposed surface of the intermediate layer 106 may be carried out. Thereafter, the intermediate structures are brought into direct or indirect contact to produce the aforementioned stack.

Prior to, or after, the contact, the stack is heated (indicated by the opposing arrows in FIG. 2). In particular, the intermediate layer 106 and the second material layer 104 are taken to a temperature sufficient to induce ion migration and formation of an anodic bond therebetween. The temperature is sufficiently high for the second material layer 104 to become slightly conductive. The particular temperature is dependent on the particular materials and material properties of the intermediate layer 106 and the second material layer 104. It is known to take the temperature up to about 500-600° C. to induce an anodic bond with an oxide glass, however, as will be discussed later herein, such high temperatures may be avoided by appropriate, additional processing.

In addition to the above-discussed temperature characteristics, mechanical pressure (again, indicated by the arrows in FIG. 2) is applied to the intermediate assembly. The pressure range may be between about 1 to about 50 psi, although other pressures are possible so long as breakage or other types of damage to the materials of the stack are avoided.

A voltage, indicated by the (+) and (−) leads is also applied across the layers between which the anodic bond is desired. In the present example, the voltage potential is applied across the intermediate layer 106 and the second material layer 104, with a positive potential (+) applied to the intermediate layer 106 with respect to a lower potential (−), shown with a solid lead line applied to the second material layer 104.

It is noted that the material characteristics of the second material layer 104 include the existence of modifier positive ions, such as alkali or alkaline earth ions. By way of example, the alkali or alkaline earth ions may include one or more of: Li⁺¹, Na⁺¹, K⁺¹, Cs⁺¹, Mg⁺², Ca⁺², Sr⁺², and Ba⁺². The application of the elevated temperature and the voltage potential causes the alkali or alkaline earth ions in the second material layer 104 to move away from the interface between the layers 104, 106 further into the bulk of the layer 104. More particularly, the positive ions of the second material layer 104 (within the oxide glass material), including many, most, or substantially all modifier positive ions, migrate away from the higher voltage potential (+) imposed by the intermediate layer 106 toward the lower potential (−) applied to the bulk of the second material layer 104. The migration of the positive ions leaves an excess of negatively charged ions, such as oxygen ions, which may migrate toward the interface between the layers 104, 106. This excess of negatively charged ions results in metal oxide formation at the interface and a resultant anodic bond.

The migration of positive ions within the second material layer 104 forms: (i) a reduced positive ion concentration layer adjacent to the intermediate layer 106, which is depleted of some, most, or substantially all modifier positive ions; (ii) an enhanced positive ion concentration layer, adjacent to the reduced positive ion concentration layer, further from the intermediate layer 106, and including the modifier positive ions that diffused and migrated; and (iii) a bulk material layer, adjacent to the enhanced positive ion concentration layer, still further from the intermediate layer 106, and which is generally unadulterated as regards ion migration. This formation results in barrier functionality, i.e., preventing positive ion migration back from the oxide glass or oxide glass-ceramic, through the reduced positive ion concentration layer, and into the intermediate layer 106.

As mentioned earlier, there is choice of which bond is to be a deposition bond and which bond is to be an anodic bond. In the above example, there is a deposition bond between the intermediate layer 106 and the first material layer 102, and an anodic bond between the intermediate layer 106 and the second material layer 104. This may be reversed, in which case the intermediate layer 106 (e.g., the metal) may be deposited on the second material layer 104, and an anodic bond may be induced between the intermediate layer 106 and the first material layer 102. In this case, the anodic bond would be influenced by a positive potential (+) applied to the intermediate layer 106 with respect to a lower potential (−), shown with a dashed lead line, applied to the first material layer 102. In such a case, the resultant formation of an oxide layer, a reduced positive ion concentration layer, an enhanced positive ion concentration layer, and a bulk layer would occur in, or with respect to, the first material layer 102.

After the intermediate assembly is held under the conditions of temperature, pressure and voltage for a sufficient time, the voltage is removed and the intermediate assembly is allowed to cool to room temperature, resulting in the structure 100. Among the desirable properties of the structure 100 is the relatively strong bond among the layers 102, 104, 106. In particular, although the intermediate layer 106 is not anodically bonded to the first material layer 102, the bond between the two is quite strong. The anodic bond between the intermediate layer 106 and the second material layer 104 is also very strong. Moreover, the seal created between the first and second material layers 102, 104 (via the intermediate layer 106 and the anodic bond) is characterized by very high hermeticity, far exceeding the hermeticity of glass frit bonding and organic adhesive bonding, and/or other types of bonds. Consequently the application of structure 100 in other devices and systems is tremendous, such as in the aforementioned DLP context, which will be developed further later herein.

Additional and/or alternative materials and/or processes will now be discussed. As mentioned above, the stack (the first material layer 102, the intermediate layer 106, and the second material layer 104) are taken to a temperature sufficient to induce the ion migration and formation of the anodic bond there between. As also mentioned, known processes take the temperature up to about 500-600° C. to induce the anodic bond in oxide glasses. It is noted that, in some applications, exposure of the stack to such high temperatures has limited or no disadvantages. However, in other applications, such high temperatures may disadvantageously alter certain characteristics of one or more of the layers 102, 104, 106 in such a way as to make them unsuitable for a downstream process or device.

For example, it has been discovered that elevating the stack of layers 102, 104, 106 to about 550° C. for a period of time to induce an anodic bond (such as about 30 minutes or more) may adversely impact certain optical properties of the stack. An experiment was conducted using an anti-reflective (AR) coated sheet of window glass and elevating the temperature thereof to about 550° C. for about 30 minutes. The resultant transmission properties of the AR coated glass changed rather significantly. Prior to the heating step, the transmission of light in the wavelength rage of 420 nm to 680 nm was above 98%. Post heating, however, the transmission of light over some of the same wavelength rage fell to 91%. This reduction in transmission may not be suitable for some applications, such as for the front glass of a DLP device, which may need to be on the order of at least 97% over the wavelength rage of 420 nm to 680 nm.

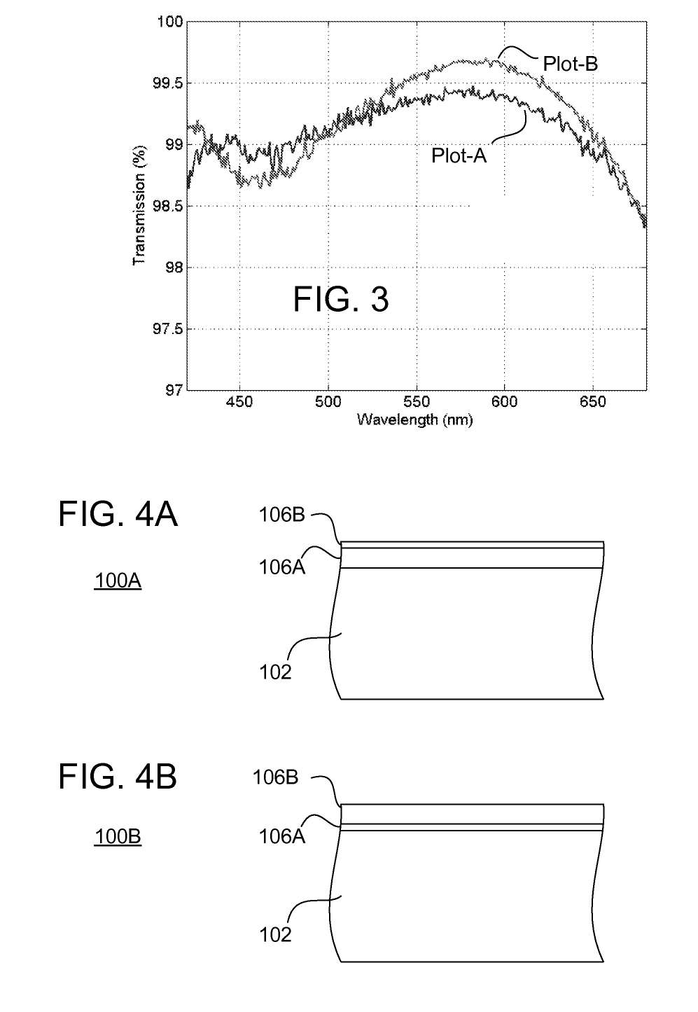

With reference to FIG. 3, a further experiment was conducted using an AR coated sheet of window glass and elevating the temperature thereof to about 450° C. for about 20 minutes. The resultant transmission properties of the AR coated glass did not change significantly. Prior to the heating step, plot-A, the transmission of light in the wavelength rage of 420 nm to 680 nm was above about 98%. Post heating, plot-B, although there was some shifting, the transmission of light over the same wavelength rage remained above about 98%.

It has been discovered that, with appropriate pre-bonding processing, the anodic bonding process may be carried out at temperatures significantly below 500-600° C., such as: less than 500° C., less than about 400° C., less than about 300° C., between about 275° C. and 350° C.; between about 350° C. and 450° C., or between about 370° C. and 400° C. It is believed that by maintaining the anodic bonding temperature within these constraints will result in improved optical characteristics of the structure 100, thereby permitting the structure to be used in more applications that otherwise possible. In addition, these lower temperature result in other advantages, such as reduced processing costs, reduced processing time, reduced (or minimized) bonding-induced stresses and/or warpage (which manifest during and/or after cooling), and a reduced sensitivity to any mismatches of the respective coefficients of thermal expansion (CTEs) in the stack during bonding.

Moreover, it is believed that, using suitable pre-bonding processing to reduce the anodic bonding temperature, will not significantly reduce (if at all) the resulting anodic bond strength. This is counter-intuitive as it is well known that reducing the temperature at which the anodic bonding process is carried out usually results in reduced bond strength.

The subject additional processing may include treating the first or second material layer 102, 104 (whichever is to be anodically bonded) such that the layer includes an excess of modifier positive ions. Again, these modifier positive ions may include alkali and/or alkaline earth ions, such as Li⁺¹, Na⁺¹, K⁺¹, Cs⁺¹, Mg⁺², Ca⁺², Sr⁺², and/or Ba⁺².

In the presence of such excess of modifier positive ions, the voltage potential (and resultant electric field) drives the modifier ions away from the interface between the layers (e.g., layers 106 and 104) and causes them to diffuse toward the lower potential at the bulk material of the second material layer 104. A higher concentration of modifier positive ions will leave more dangling reactive oxygen ions available to bond with the intermediate layer 106 as the oxide chemical bond is formed.

There are a number of ways to achieve the aforementioned excess of modifier positive ions on or in the second material layer 104. One way includes applying a solution, a salt, or other vehicle containing the modifier positive ions to the second material layer 104, followed by elevating the temperature thereof, such that the modifier positive ions diffuse onto, and/or into, the second material layer 104 at a region at which the anodic bonding is to occur. For example, a salt solution (e.g., containing NaCl) may be applied to the second material layer 104, or the second material layer 104 may be soaked in such solution. Alternatively, a sputtering, evaporation, or implantation process may be carried out to apply the modifier positive ions. In a further alternative, the excess modifier positive ions may be achieved by applying an enriched oxide (an oxide containing an excess of the modifier positive ions) onto the second material layer 104. In a further alternative process, the second material layer 104 may be enriched with the modifier positive ions during formation, and the layer 104 may be elevated to a temperature sufficient to produce an oxide (e.g., SiO₂) on a surface thereof which contains an excess of the modifier positive ions (e.g., Na⁺). Thereafter, the second material layer 104 is subject to annealing temperatures, which cause the modifier positive ions to diffuse onto/into the material.

Turning again to FIG. 2, the first and second material layers 102, 104 may be formed from any number of materials, such as: (i) one or more glass materials, such as oxide glass materials; (ii) glass-ceramic materials; (iii) one or more oxide insulator materials; (iv) one or more oxide insulator materials; and (v) one or more semiconductor materials.

When the material layer to which the intermediate layer 106 is to be anodically bonded is an insulator, such as a glass, glass-ceramic, etc. (whether oxide or non-oxide) then the intermediate layer 106 may be formed from a metal, such as the aforementioned highly conductive materials, Titanium (Ti), Aluminum (Al), Chromium (Cr), and/or a TiAl alloy). The high conductivity is advantageous because, during the anodic bonding process, when the positive voltage potential (+) is connected directly to the metal intermediate layer 106, the resultant electric field is effectively applied across the bonding materials, which achieves substantially uniform electrical field distribution across the layers of the stack. Such metal film exhibits an intrinsic oxide form and, therefore, during the anodic bonding process, the metal reacts with negatively charged oxygen ions at the interface, which are left behind as a result of the positive modifier ion migration away from the positive voltage potential.

Alternatively, the intermediate layer 106 may be formed from an oxide material, so long as the characteristics thereof are conducive to forming the anodic bond. For example, when the oxide material is non-stoichiometric (such as by way of an oxygen deficiency) the particular characteristics of the oxygen deficiency and/or crystallinity may affect the bonding strength between the oxide material of the intermediate layer 106 and the insulator material layer 102 or layer 104. Thus, control of the stoichiometry of the intermediate layer 106, controls the anodic bonding properties of the structure 100, such as the bond strength. In alternative embodiments, the intermediate layer 106 may be formed from a non-stoichiometric, conductive oxide material, which may additionally be transparent. The conductivity and transparency of an oxide material are largely influenced by the crystallinity and oxygen deficiency characteristics. One suitable transparent, conductive oxide material is Indium Tin Oxide (ITO), again, where the stoichiometry is properly controlled. Another suitable material is Fluorine-doped Tin Oxide. It is contemplated that amorphous and/or polycrystalline oxide materials may be used to form the intermediate layer 106.

Reference is now made to FIGS. 4A-4B, which illustrate further alternative methods and structures that may be employed in manufacturing the structure 100 and/or other embodiments disclosed and/or described herein. FIG. 4A shows a cross-section (or side view) of a structure 100A that includes the first material layer 102 on which the intermediate layer 106 is disposed. The intermediate layer 106, however, is formed from a plurality of layers, including a first intermediate layer 106A disposed on the surface of the first material layer 102, followed by a second intermediate layer 106B disposed on a surface of the first intermediate layer 106A.

In one or more embodiments, the first intermediate layer 106A is formed from an oxide material, while the second intermediate layer 106B is formed from a metal film (which may be ultra-thin). The addition of the metal film 106B may improve the conductivity of the first intermediate layer 106A, thereby also preserve or improve other characteristics of the overall intermediate layer 106. For example, conductivity is improved, though the transparency (e.g., to UV light) is reduced by a thin metal film on top of the transparent oxide film. The reduction in transparency may be tolerated so long as a sufficient amount of light may nevertheless pass through the intermediate layer 106, such as permitting about 20-70% of UV light to pass therethrough. Thus, in accordance with one or more embodiments, a suitable configuration may be to dispose a conductive, transparent, non-stoichiometric (oxygen deficient) oxide as a first intermediate layer 106A on the first material layer 102. By way of example, the thickness of the oxide 106A may be on the order of about 50-300 nm. An ultra-thin metal film may be employed as the second intermediate later 106B. By way of example, the thickness of the metal film 106B may be in the ranges of about 2-50 nm, about 1-30 nm, 1-15 nm, 2-10 nm, etc. While the above thicknesses are contemplated, in applications where transparency is desired, care should be made to ensure that sufficient transparency is maintained, especially at thicknesses of the metal film above about 20 nm.

It is noted that the metal film of the second intermediate layer 106B includes an intrinsic oxide form, which reacts with negatively charged oxygen ions at the interface during anodic bonding. Thus, it is believed that in alternative embodiments, a stoichiometric oxide may be employed as a first intermediate layer 106A and still attain a suitable anodic bond.

In accordance with a further alternative, FIG. 4B, the first intermediate layer 106A is formed from a metal, while the second intermediate layer 106B is formed from an oxide material. Again, the addition of the metal film of the first intermediate layer 106A may improve the conductivity of the second intermediate layer 106B and, thereby also preserve or improve other characteristics of the overall intermediate layer 106.

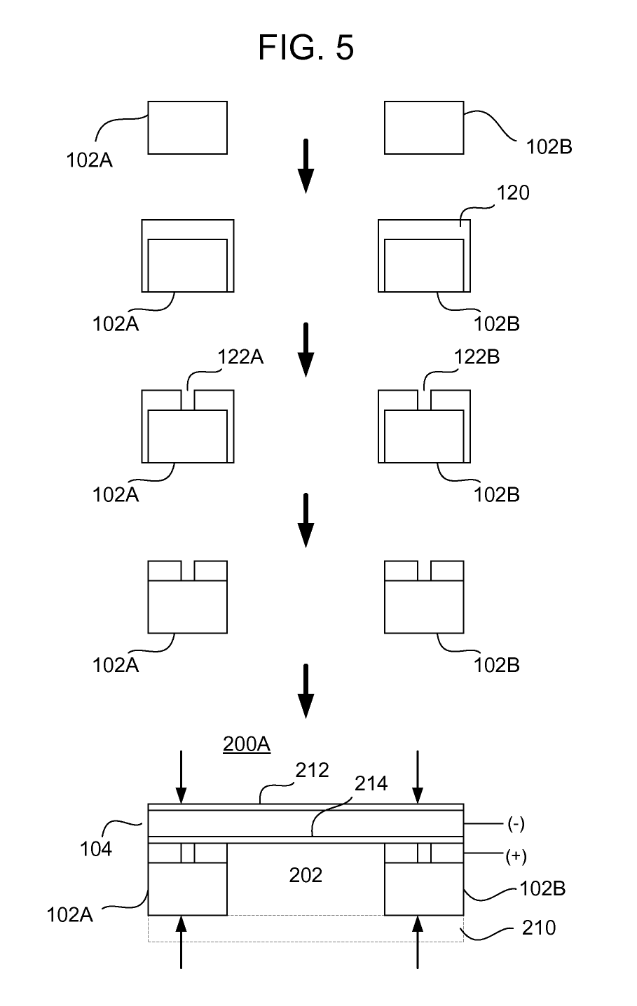

Reference is now made to FIG. 5, which is a schematic diagram illustrating methods and intermediate structures formed during the manufacture of an alternative structure 200A. The structure 200A may be used in any suitable application, such as in the formation of one or more DLP devices. The structure 200A includes a first material layer 102 that has been formed from a patterned sheet of transparent insulator material, such as glass, glass-ceramic, etc. The patterning is such that one or more apertures 202 (only one being shown) extend therethrough, each aperture being circumscribed by respective walls (only walls 102A and 102B being visible in the cross-section shown) of the material layer 102. In a particular embodiment, the first material layer 102 includes a plurality of such apertures 202 and corresponding walls, each such aperture defining a window area for a respective DLP device.

The structure 200A also includes a second material layer 104, also formed of transparent insulator material, such as glass, glass-ceramic, etc. An intermediate layer 106, formed substantially from metal only, is located between the first and second material layers 102, 104 without obstructing any of the apertures 202. The intermediate layer 106 is not anodically bonded to the first material layer 102, but is anodically bonded to the second material layer 104. Thus, the stack of the structure 200A may exhibit any or all of the characteristics discussed hereinabove with respect to FIGS. 1-2.

The structure 200A may also include one or more micro-electromechanical systems (MEMS) 210, only one being shown, each coupled to the first material layer 102 and in registration with a given one of the apertures 202. In this way, light may be directed from the respective MEMS 210 through the given aperture 202 and through the second material layer 104. In such configuration, the first material layer 102 serves as an interposer layer and the second material layer 104 serves as a front glass layer of the DLP device. In order to improve the optical properties of the light transmission from the MEMS 210 and through the second material layer 104, the layer 104 may be coated on one or both sides with an AR coating 212, 214.

In order to produce the structure 200A, the patterned first material layer 102 is exposed to a deposition process, to deposit a precursor layer 120 of the metal thereon. The thickness of the first material layer 102 may be on the order of about 20-500 nm. The thickness of the metal layer 120 may on the order of about 20-300 nm. Other suitable thicknesses for the metal layer 120 may be between about 15-300 nm, or better between about 20-100 nm. As an optional sub-process, one or more gaps 122 may be formed in the metal layer 120, such as one gap 122A, 122B, etc. along each wall 102A, 102B, etc. The gaps 122 may be formed via known lithography techniques. Next, the metal 120 that was disposed along the walls 102A, 102B of the first material layer 102 is removed using a suitable technique, such as wet or dry etching. This may require masking the top surface of the metal layer 120 during such etching. Thereafter, the intermediate layer 106 is anodically bonded to the second material layer 104 via the process described above. The purpose of the gaps 122 is to provide a channel through which light (e.g., UV light) may propagate in order to cure an epoxy that couples the MEMS 210 to the first material layer 102.

In a particular embodiment, the resultant structure 200A includes a plurality of MEMS 210 coupled to the first material layer 102, each MEMS 210 in registration with a particular aperture 202 (window). In order to produce individual DLP elements, the first material layer 102, the second material layer 104, and the intermediate layer 106 is diced in registration with the respective MEMS 210 and apertures 202 to produce respective light projection elements.

Advantageously, the bonding characteristics of the intermediate layer 106 to the second material layer 104, specifically the anodic bond thereof, exhibits significantly high hermeticity, thereby providing very good protection of the MEMS 210 and elevated reliability of the structure 200A (and each DLP element). In addition, the treatment of the second material layer 104 to include an excess of modifier positive ions advantageously results in a strong and hermetically potent anodic bond between the intermediate layer 106 and the second material layer 104, even at relatively low bonding temperatures (e.g., less than 500° C.). Therefore, the optical properties of the second material layer 104, e.g., the transmission properties of the front glass, are not compromised. Additionally, the lower bonding temperature results in the aforementioned reduced processing costs, reduced processing time, reduced (or minimized) bonding-induced stresses and/or warpage, and reduced sensitivity to CTE mismatches.

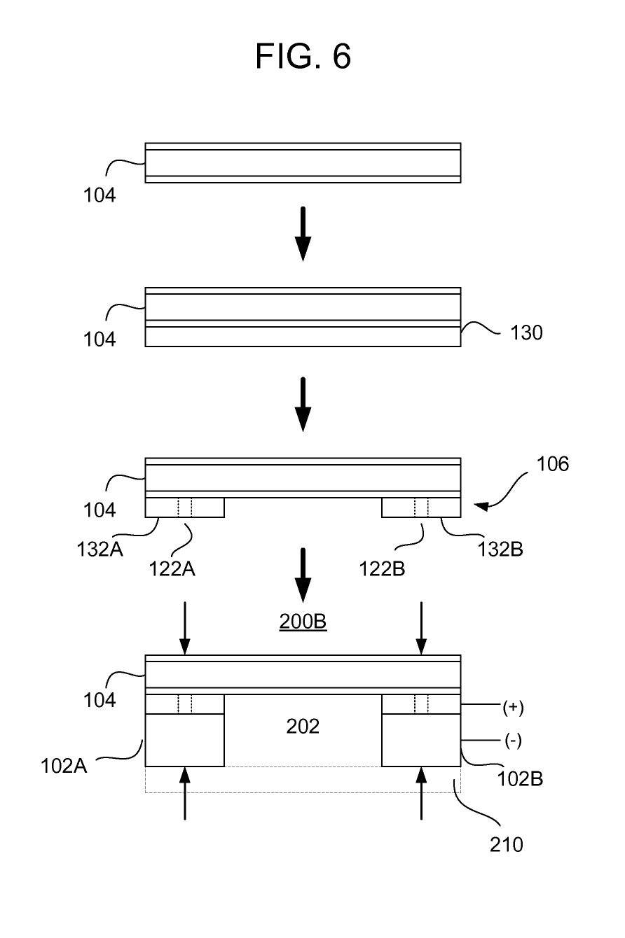

Reference is now made to FIG. 6, which is a schematic diagram illustrating methods and intermediate structures formed during the manufacture of a further alternative structure 200B. The structure 200B may also be used in any suitable application, such as in the formation of one or more DLP devices. The structure 200B includes a first material layer 102 that has been formed from a patterned sheet of transparent insulator material, such as glass, glass-ceramic, etc., thereby exhibiting the apertures 202 therethrough circumscribed by respective walls 102A, 102B, etc. The structure 200B also includes a second material layer 104 coupled to the first material layer 102 via an intermediate layer 106, formed substantially from metal only. In this example, the intermediate layer 106 is anodically bonded to the first material layer 102, but is not anodically bonded to the second material layer 104. The structure 200B may also include one or more micro-electromechanical systems (MEMS) 210, each coupled to the first material layer 102 and in registration with a given one of the apertures 202.

In order to produce the structure 200B, the second material layer 104 (which may have been coated with an AR material) is exposed to a deposition process, to deposit a precursor layer 130 of the metal thereon. The thickness of the second material layer 104 may be on the order of about 20-500 nm. The thickness of the metal layer 130 may be on the order of about 20-300 nm. Other suitable thicknesses for the metal layer 130 may be between about 15-300 nm, or between about 20-100 nm. Next, the metal layer 130 is patterned using a suitable technique, such as wet or dry etching and masking. This leaves a pattern of metal, operating as the intermediate layer 106, where the pattern includes respective runs 132A, 132B that are sized and shaped to geometrically correspond with the walls 102A, 102B, etc. of the first material layer 102. As an optional sub-process, one or more gaps 122 may be formed in the metal layer runs 132, such as one such gap 122A, 122B, etc. along each run 132A, 132B, etc. Again, the gaps 122 may be formed via known lithography techniques. Thereafter, the intermediate layer 106 is anodically bonded to the first material layer 102 via the process described above. The MEMS 210 may then be coupled to the first material layer 102 as in prior embodiments, and subsequent dicing may be employed to form individual DLP elements.

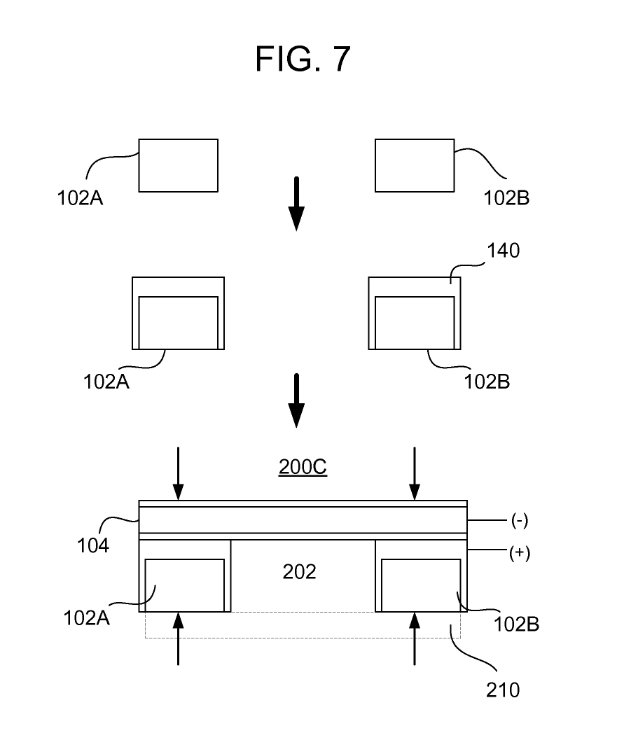

Reference is now made to FIG. 7, which is a schematic diagram illustrating methods and intermediate structures formed during the manufacture of a further alternative structure 200C. The structure 200C may also be used in any suitable application, such as in the formation of DLP devices. The structure 200C includes a first material layer 102 that has been formed from a patterned sheet of transparent insulator material, such as glass, glass-ceramic, etc., thereby exhibiting the apertures 202 therethrough circumscribed by respective walls 102A, 102B, etc. The structure 200C includes a second material layer 104 coupled to the first material layer 102 via an intermediate layer 106, formed substantially from an oxide material only. In this example, the intermediate layer 106 is anodically bonded to the second material layer 104, but is not anodically bonded to the first material layer 102. The structure 200C may also include one or more micro-electromechanical systems (MEMS) 210, each coupled to the first material layer 102 and in registration with a given one of the apertures 202.

In order to produce the structure 200C, the patterned first material layer 102 is exposed to a deposition process, to deposit a precursor layer 140 of the oxide material thereon. The thickness of the first material layer 102 may be on the order of about 20-500 nm. The particular oxide material may be any of the aforementioned, such as the transparent, conductive, non-stoichiometric (oxygen depleted) oxide. The thickness of the oxide layer 140 may be on the order of about 50-300 nm. Since the oxide is transparent, there is no need for gaps 122 (which were desirable to transmit UV light through opaque metal). Of course, if non-transparent (opaque) oxide material is employed, then such gaps 122 may be desirable. Also, as the oxide layer 140 is transparent, there is no need to remove the material that is disposed along the walls 102A, 102B of the first material layer 102. If desired, however, such material may also be removed. The oxide layer 140, whether modified after deposition or not, becomes the intermediate layer 106. The intermediate layer 106 is anodically bonded to the second material layer 104 via the process described above. The MEMS 210 may then be coupled to the first material layer 102 as in prior embodiments, and subsequent dicing may be employed to form individual DLP elements.

In an alternative arrangement (not shown), the oxide material layer 106 (again preferably a transparent, conductive, non-stoichiometric, oxygen depleted oxide) may be disposed on the second material layer 104. In this arrangement, since the oxide exhibits transparency, there need not be any patterning of the intermediate layer 106. This is in contrast to the case in which the intermediate layer 106 is a metal disposed on the second material layer (FIG. 6), which would block light from passing through the second material layer 104. The intermediate layer 106 is then anodically bonded to the first material layer 102 via the process described above.

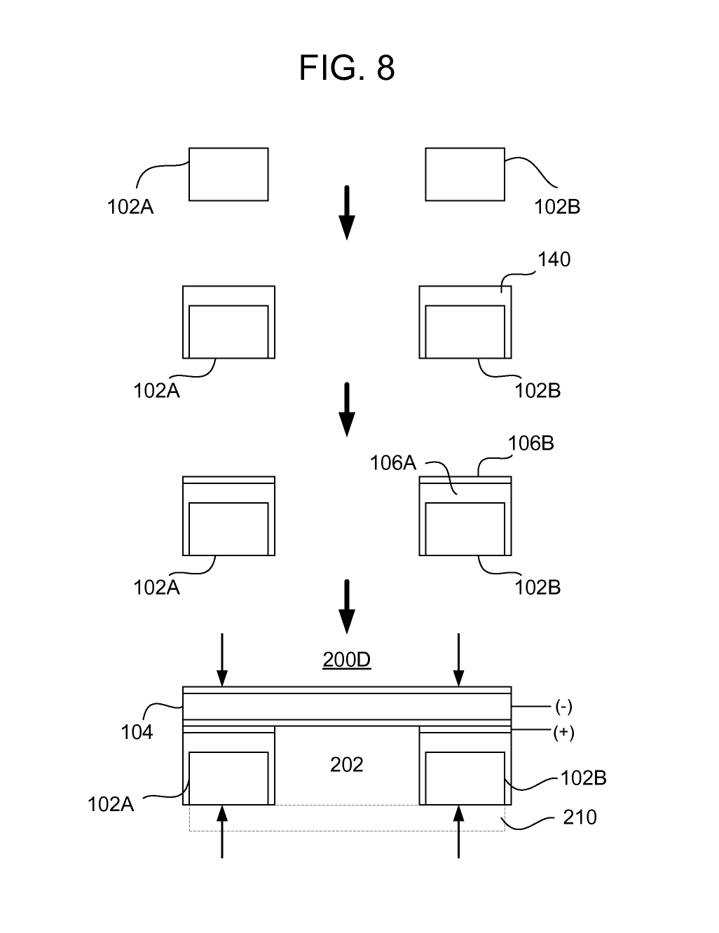

Reference is now made to FIG. 8, which is a schematic diagram illustrating methods and intermediate structures formed during the manufacture of a further alternative structure 200D, which again is suitable for DLP devices. The structure 200D includes a first material layer 102 that has been formed from a patterned sheet of transparent insulator material, such as glass, glass-ceramic, etc., thereby exhibiting the apertures 202 therethrough circumscribed by respective walls 102A, 102B, etc. The second material layer 104 is coupled to the first material layer 102 via an intermediate layer 106, formed substantially from a combination of layers: a first intermediate layer 106A; and a second intermediate layer 106B. The first intermediate layer 106A is formed from an oxide material, while the second intermediate layer 106B is formed from a metal film (which may be ultra-thin). In this example, the intermediate layer 106 is anodically bonded to the second material layer 104, but is not anodically bonded to the first material layer 102. The structure 200D may also include one or more micro-electromechanical systems (MEMS) 210, each coupled to the first material layer 102 and in registration with a given one of the apertures 202.

In order to produce the structure 200D, the patterned first material layer 102 is exposed to a deposition process, to deposit a precursor layer 140 of the oxide material thereon. The thickness of the first material layer 102 may be on the order of about 20-500 nm. The particular oxide material may be any of the aforementioned, such as the transparent, conductive, non-stoichiometric (oxygen depleted) oxide. The thickness of the oxide layer 140 may be on the order of about 50-300 nm. The oxide layer 140, whether modified after deposition or not, becomes the first intermediate layer 106A. The metal second intermediate layer 106B is disposed on the first intermediate layer 106A. An ultra-thin layer, on the order of about 2-15 nm may be all that is required. Other suitable thicknesses of the metal may be on the order of about 2-50 nm, 1-30 nm, 1-15 nm, 2-10 nm, etc., depending on the transparency desired. If necessary, gaps (not shown) may be patterned through the metal. The intermediate layer 106 (specifically the metal second intermediate layer 106B) is anodically bonded to the second material layer 104 via the process described above. The MEMS 210 may then be coupled to the first material layer 102 as in prior embodiments, and subsequent dicing may be employed to form individual DLP elements.

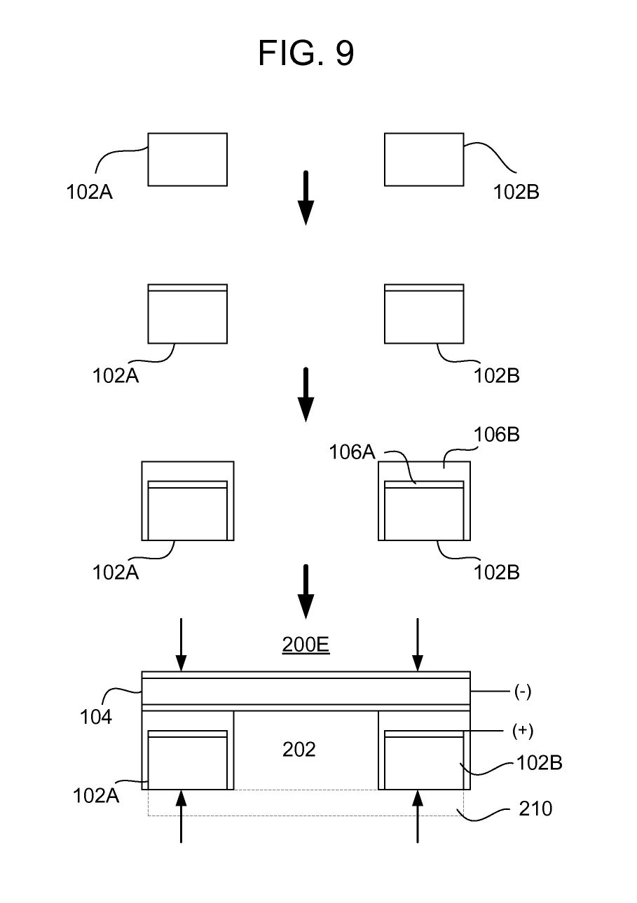

Reference is now made to FIG. 9, which is a schematic diagram illustrating methods and intermediate structures formed during the manufacture of a further alternative structure 200E, which again is suitable for DLP devices. The structure 200E is similar to the structure 200D (FIG. 8), except there is a reversal of the intermediate layers 106A, 106B. In particular, the first intermediate layer 106A is formed from a metal, while the second intermediate layer 106B is formed from an oxide material. In order to produce the structure 200E, the patterned first material layer 102 is exposed to a deposition process, to deposit a precursor layer 130 of the metal material thereon, which again may be relatively thin. If necessary, gaps (not shown) may be patterned through the metal. The oxide second intermediate layer 106B is disposed on the first intermediate layer 106A. The thickness of the oxide layer 106B may be on the order of about 50-300 nm. The intermediate layer 106 (specifically the oxide second intermediate layer 106B) is anodically bonded to the second material layer 104 via the process described above. The MEMS 210 may then be coupled to the first material layer 102 as in prior embodiments, and subsequent dicing may be employed to form individual DLP elements.

Although not shown, those skilled in the art will appreciate that the embodiment of FIG. 9 may be modified such that the first and second intermediate layers 106A, 106B are disposed on the second material layer 104 (in a non-anodic fashion), patterned, and then the intermediate layer 106 may be anodically bonded to the first material layer 102.

In addition, in connection with the discussion above with respect to FIGS. 8 and 9, it is noted that alternative embodiments may dispose the oxide material of the intermediate layer 106 in between the metal material and one of the first and second material layers 102, 104 to which anodic bonding is to take place. In such circumstances, the oxide material must anodically bond to the first or second material layers 102, 104. Thus, the oxide material should be non-stoichiometric (e.g., oxygen depleted), and preferably also include the characteristics of being transparent and conductive.

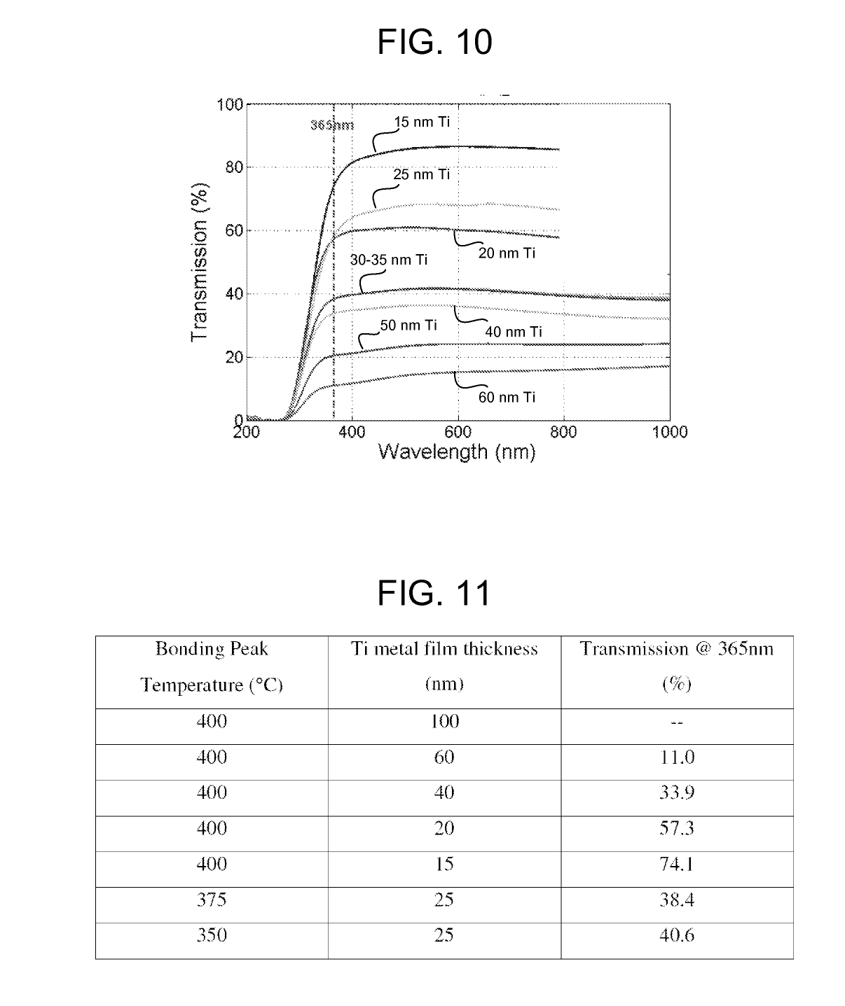

Reference is now made to FIGS. 10 and 11, which show the results of an experiment, where two glass material layers were anodically bonded through an intermediate metal layer under differing conditions to test light transmission and bonding strength. A number of first glass material layers was deposited with a titanium (Ti) metal film or an aluminum (Al) metal film, each of a different thicknesses, ranging from 15-100 nm. The first glass material layer was Corning Incorporated's Eagle XG® (which is a glass having suitable modifier positive ions). The second glass material layer was Borofloat® glass (a multi-functional, borosilicate float glass) that may be obtained from Schott. During the bonding, the electrical field produced by an electrical potential of about 300 V was directly applied to Ti or Al metal film. The lowest bonding peak temperature was 350° C. and the highest was 400° C. As illustrated in FIG. 10, by adjusting the thickness of the Ti or Al metal film between 15-100 nm, the bonded glass material layers exhibited differing levels of semi-transparency after anodic bonding. The table presented in FIG. 11 shows the relationships among the bonding temperature, metal film thickness, and transparency. The bonding strength was measured using the well-known wedge test, which showed that the glass broke before the bond between the first and second glass material layers separated irrespective of temperature.

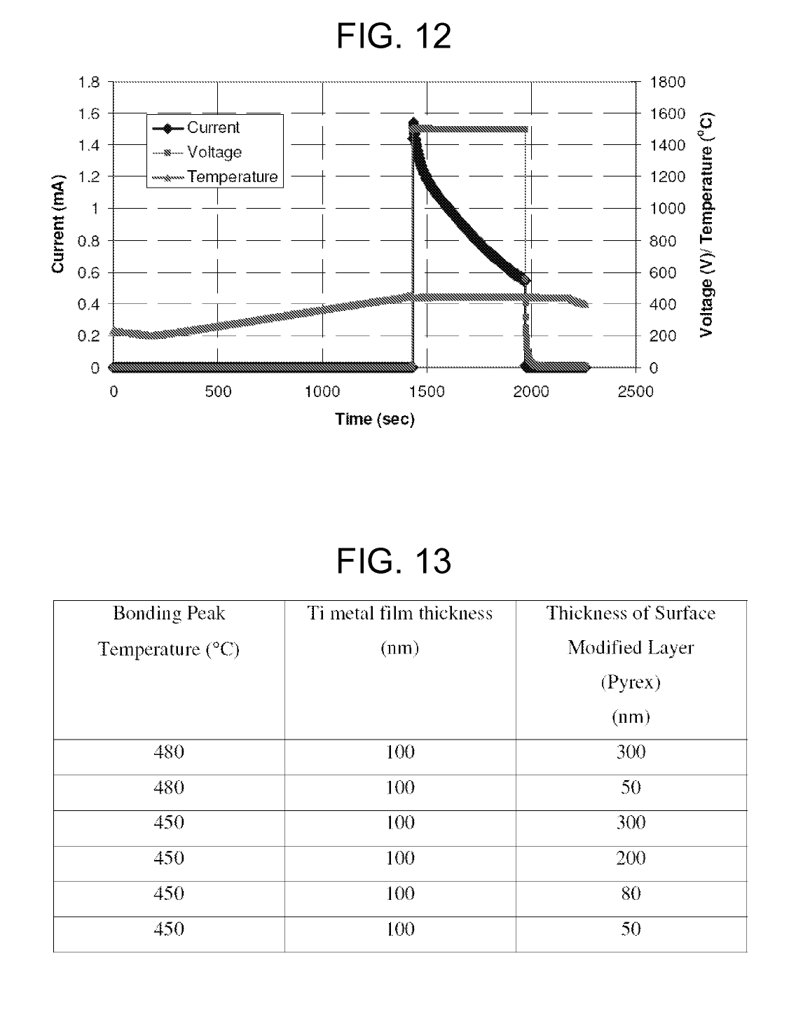

Reference is now made to FIGS. 12 and 13, which show the results of a further experiment, where two glass material layers were anodically bonded through an intermediate metal layer under differing surface modifications of one of the glass material layers. In this anodic bonding experiment, both glass material layers were formed from Corning Incorporated's Eagle XG® glass. A surface of one of the glass material layers of each bonded pair was modified, such that a very thin layer (about 50-400 nm) was enriched with Na. In particular, the Na-enriched layer was formed via a Pyrex composition and such Pyrex film was evaporated onto the surface of the glass material layer. The non-modified surface of the glass material layer was coated with a Ti metal film or Al metal film (of about 100 nm thickness). FIG. 12 illustrates the time, voltage, current, and temperature characteristics of the experiment. The applied anode electrical potential was directly applied to the Ti or Al metal film, while the cathode potential was applied to the glass material layer having the Na-enriched surface. Thus, the bonding interface was between the Ti or Al metal film and the Na-enriched layer (i.e., the Pyrex layer with thickness of 50-400 nm). The bonding peak temperatures ranged from about 450° C. to 480° C. FIG. 13 is a table showing the relationships among the bonding temperature, metal film thickness, and modified layer thickness. The bonding strength was measured using the well-known wedge test, which showed that the glass broke before the bond between the first and second glass material layers separated irrespective of temperature.

Although the aspects, features, and embodiments disclosed herein have been described with reference to particular details, it is to be understood that these details are merely illustrative of broader principles and applications. It is therefore to be understood that numerous modifications may be made to the illustrative embodiments and that other arrangements may be devised without departing from the spirit and scope of the appended claims.

1. A method, comprising:
disposing an intermediate layer formed from at least one of: a metal, a conductive oxide, and combined layers of the metal and the conductive oxide, on one of a first material layer and a second material layer; and
coupling the first and second material layers together via an anodic bond between the intermediate layer and the other of the first and second material layers.

2. The method of claim 1, wherein at least one of:
the intermediate layer is formed from a transparent conductive oxide material;
the intermediate layer is formed from a non-stoichiometric conductive oxide material;
the intermediate layer is formed from a non-stoichiometric, oxygen depleted, conductive oxide material;
the conductive oxide of the intermediate layer is formed from a material selected from the group consisting of Indium Tin Oxide (ITO) and Fluorine-doped Tin Oxide; and
the intermediate layer is formed from the metal, where the metal is taken from the group consisting of Titanium (Ti), Aluminum (Al), Chromium (Cr), a TiAl alloy.

3. The method of claim 1, wherein the step of anodically bonding the intermediate layer to the other of the first and second material layers includes:
forming a reduced positive ion concentration layer, depleted of modifier positive ions, in the other of the first and second material layers, which is adjacent to the intermediate layer, followed by an enhanced positive ion concentration layer, including the modifier positive ions diffused from the reduced positive ion concentration layer.

4. The method of claim 3, wherein the modifier positive ions include at least one of: Li⁺¹, Na⁺¹, K⁺¹, Cs⁺¹, Mg⁺², Ca⁺², Sr⁺², and Ba⁺².

5. The method of claim 1, wherein at least one of:
the first and second material layers are formed from one or more glass materials;
the first material layer is formed from a semiconductor material and the second material layer is formed from an oxide insulator material; and
the first material layer is formed from an oxide insulator material and the second material layer is formed from an oxide insulator material.

6. The method of claim 1, further comprising processing the other of the first and second material layers, prior to the step of anodically bonding the intermediate layer thereto, such that the layer includes an excess of modifier positive ions.

7. The method of claim 6, wherein the step of processing includes:
applying a solution, salt, or other vehicle containing the modifier positive ions to the other of the first and second material layers; and
elevating a temperature of the vehicle and the other of the first and second material layers, such that the modifier positive ions diffuse at least one of onto, and into, the other of the first and second material layers in a region at which the anodic bonding is to occur.

8. The method of claim 7, wherein the step of applying includes at least one of:
applying to, or soaking, the other of the first and second material layers in a salt solution containing the modifier positive ions;
sputtering the modifier positive ions onto the other of the first and second material layers;
evaporating the modifier positive ions onto the other of the first and second material layers;
performing ion implantation the modifier positive ions into the other of the first and second material layers;
sputtering alkali ion enriched glass onto the other of the first and second material layer;
evaporating alkali ion enriched glass onto the other of the first and second material layer; and
heating the other of the first and second material layers, which has been enriched with the modifier positive ions during formation, to a temperature sufficient to produce an oxide on a surface thereof which contains an excess of the modifier positive ions.

9. The method of claim 6, wherein the modifier positive ions include one or more alkali or alkaline earth ions.

10. The method of claim 9, wherein the modifier positive ions include at least one of: Li⁺¹, Na⁺¹, K⁺¹, Cs⁺¹, Mg⁺², Ca⁺², Sr⁺², and Ba⁺².

11. The method of claim 6, wherein the step of coupling the first and second material layers together includes:
applying a temperature to induce the anodic bond between the intermediate layer and the other of the first and second material layers,
wherein the temperature is substantially less than 500° C.

12. The method of claim 11, wherein the temperature is one of: less than about 400° C., between about 275° C. and 350° C.; between about 350° C. and 450° C., and between about 370° C. and 400° C.

13. The method of claim 1, further comprising:
forming the first material layer by patterning a glass sheet to include one or more apertures therethrough;
forming the second material layer from a glass sheet;
disposing the intermediate layer on the one of the first and second material layers;
contacting the intermediate layer with the other of the first and second material layers without obstructing the one or more apertures; and
anodically bonding the intermediate layer to other of the first and second material layers.

14. The method of claim 13, wherein the steps of contacting and anodically bonding include:
contacting the intermediate layer with the second material layer without obstructing the one or more apertures; and
anodically bonding the intermediate layer to the second material layer, without anodically bonding the intermediate layer to the first material layer.

15. The method of claim 13, wherein the steps of contacting and anodically bonding include:
contacting the intermediate layer with the first material layer without obstructing the one or more apertures; and
anodically bonding the intermediate layer to the first material layer, without anodically bonding the intermediate layer to the second material layer.

16. The method of claim 13, further comprising:
coupling a respective micro-electromechanical system (MEMS) to the first material layer and in registration with each of the apertures such that light may be directed from the respective MEMS through the given aperture and through the second material layer;
dicing the first material layer, the second material layer, and the intermediate layer in registration with the respective MEMS and apertures to produce respective light projection elements.

17. The method of claim 1, further comprising:
forming the first material layer by patterning a glass sheet to include one or more apertures therethrough;
forming the second material layer from a glass sheet;
disposing the intermediate layer of metal on the one of the first and second material layers;
contacting the intermediate layer with the other of the first and second material layers; and
anodically bonding the intermediate layer to the other of the first and second material layers, where application of a positive voltage potential to the intermediate layer with respect to the other of the first and second material layers induces the anodic bond therebetween.

18. The method of claim further comprising patterning one or more gaps through the intermediate layer prior to the anodic bonding step, which gaps permit light to pass between the first and second material layers through the intermediate layer after the anodic bonding step is completed.

19. The method of claim 1, further comprising:
forming the first material layer by patterning a glass sheet to include one or more apertures therethrough;
forming the second material layer from a glass sheet;
disposing the intermediate layer, of substantially only transparent conductive oxide material, on the one of the first and second material layers;
contacting the intermediate layer with the other of the first and second material layers; and
anodically bonding the intermediate layer to the other of the first and second material layers, where application of a positive voltage potential to the intermediate layer with respect to the other of the first and second material layers induces the anodic bond therebetween.

20. The apparatus of claim 19, wherein the intermediate layer is formed from a non-stoichiometric, oxygen depleted, transparent conductive oxide material.

21. The method of claim 1, further comprising:
forming the first material layer by patterning a glass sheet to include one or more apertures therethrough;
forming the second material layer from a glass sheet;
disposing a first intermediate layer, of the conductive oxide material, on the one of the first and second material layers;
disposing a second intermediate layer formed, of the metal, on the first intermediate layer;
contacting the second intermediate layer with the other of the first and second material layers; and
anodically bonding the second intermediate layer to the other of the first and second material layers, where application of a positive voltage potential to the second intermediate layer with respect to the other of the first and second material layers induces the anodic bond therebetween.

22. The method of claim 1, further comprising:
forming the first material layer by patterning a glass sheet to include one or more apertures therethrough;
forming the second material layer from a glass sheet;
disposing a first intermediate layer, of the metal, on the one of the first and second material layers;
disposing a second intermediate layer, of the conductive oxide material, on the first intermediate layer;
contacting the second intermediate layer with the other of the first and second material layers; and
anodically bonding the second intermediate layer to the other of the first and second material layers, where application of a positive voltage potential to the first or second intermediate layer with respect to the other of the first and second material layers induces the anodic bond therebetween.

23. The apparatus of claim 18, wherein the second intermediate layer is formed from a non-stoichiometric, oxygen depleted, transparent conductive oxide material.

24. An apparatus, comprising:
a first material layer;
a second material layer; and
an intermediate layer formed from at least one of: a metal, a conductive oxide, and combined layers of the metal and the conductive oxide,
wherein the first and second material layers are coupled together via an anodic bond between the intermediate layer and one of the first and second material layers.

25. The apparatus of claim 24, wherein at least one of:
the intermediate layer is formed from a transparent conductive oxide material;
the intermediate layer is formed from a non-stoichiometric conductive oxide material;
the intermediate layer is formed from a non-stoichiometric, oxygen depleted, conductive oxide material;
the conductive oxide of the intermediate layer is formed from a material selected from the group consisting Indium Tin Oxide (ITO) and Fluorine-doped Tin Oxide; and
the intermediate layer is formed from the metal, where the metal is taken from the group consisting of Titanium (Ti), Aluminum (Al), Chromium (Cr), a TiAl alloy.

26. The apparatus of claim 24, wherein at least one of:
the intermediate layer is of a thickness between about 50-300 nm; and
the intermediate layer is of a thickness between about 100-200 nm.

27. The apparatus of claim 24, wherein the one of the first and second material layers to which the intermediate layer is anodically bonded includes: a reduced positive ion concentration layer, depleted of modifier positive ions, adjacent to the intermediate layer, followed by an enhanced positive ion concentration layer, including the modifier positive ions diffused from the reduced positive ion concentration layer.

28. The apparatus of claim 27, wherein the modifier positive ions include at least one of: Li⁺¹, Na⁺¹, K⁺¹, Cs⁺¹, Mg⁺¹, Ca⁺², Sr⁺², and Ba⁺².

29. The apparatus of claim 24, wherein at least one of:
the first and second material layers are formed from one or more glass materials;
the first material layer is formed from a semiconductor material and the second material layer is formed from an oxide insulator material; and
the first material layer is formed from an oxide insulator material and the second material layer is formed from an oxide insulator material.

30. The apparatus of claim 24, wherein:
the first material layer is a patterned glass sheet including one or more apertures therethrough;
the second material layer is a glass sheet; and
the intermediate layer is located between the first and second material layers without obstructing one or more apertures, is anodically bonded to the one of the first and second material layers, and is not anodically bonded to the other of the first and second material layers.

31. The apparatus of claim 30, wherein the intermediate layer is anodically bonded to the second material layer, and is in contact with, but not anodically bonded to, the first material layer.

32. The apparatus of claim 30, wherein the intermediate layer is anodically bonded to the first material layer, and is in contact with, but not anodically bonded to the second material layer.

33. The apparatus of claim 30, wherein the one of the first and second material layers, to which the intermediate layer is anodically bonded, includes a reduced positive ion concentration layer, depleted of modifier positive ions, adjacent to the intermediate layer, followed by an enhanced positive ion concentration layer, including the modifier positive ions diffused from the reduced positive ion concentration layer.

34. The apparatus of claim 33, wherein the modifier positive ions include at least one of: Li⁺¹, Na⁺¹, K⁺¹, Cs⁺¹, Mg⁺², Ca⁺², Sr⁺², and Ba⁺².

35. The apparatus of claim 30, further comprising one or more micro-electromechanical systems (MEMS), each coupled to the first material layer and in registration with a given one of the apertures such that light may be directed from the respective MEMS through the given aperture and through the second material layer.

36. The apparatus of claim 30, wherein the intermediate layer is formed substantially only from the metal.

37. The apparatus of claim 36, wherein the intermediate layer includes one or more patterned gaps therethrough, which permit light to pass between the first and second material layers through the intermediate layer.

38. The apparatus of claim 30, wherein the intermediate layer is formed substantially only from transparent conductive oxide material.

39. The apparatus of claim 38, wherein the intermediate layer is formed from a non-stoichiometric, oxygen depleted, transparent conductive oxide material.

40. The apparatus of claim 30, wherein the intermediate layer includes a first intermediate layer formed of the conductive oxide material and a second intermediate layer formed from the metal.

41. The apparatus of claim 40, wherein:
the first intermediate layer formed of the conductive oxide material is in contact with, but not anodically bonded to, the first material layer; and
the second intermediate layer formed of the metal is anodically bonded to the second material layer.

42. The apparatus of claim 40, wherein:
the first intermediate layer formed of the conductive oxide material is in contact with, but not anodically bonded to, the second material layer; and
the second intermediate layer formed of the metal is anodically bonded to the first material layer.
